(19) United States
(12) Patent Application Publication
(10) Pub. No.: US 2019/0275804 A1
(43) Pub. Date: Sep. 12, 2019

(54) INK SUPPLY SYSTEM AND INK JET PRINTER

(71) Applicant: Roland DG Corporation, Hamamatsu-shi, Shizuoka (JP)

(72) Inventor: Naoki UEDA, Hamamatsu-shi (JP)

(21) Appl. No.: 16/347,278

(22) PCT Filed: Aug. 24, 2017
(86) PCT No.: PCT/JP2017/030244

§ 371 Date: May 3, 2019

(30) Foreign Application Priority Data
Nov. 24, 2016 (JP) 2016-227695

(51) Int. Cl. B41J 2/175

(52) U.S. Cl. CPC B41J 2/17596

(57) ABSTRACT

An ink supply system includes a main flow path including a first end that is connected to an ink container and a second end that is connected to an ink head, a pump that is provided in the main flow path and delivers, when driven, liquid toward a side of the ink head, a bypass flow path including a first connection portion that is connected to a portion of the main flow path, which is located between the pump and the first end, and a second connection portion that is connected to a portion of the main flow path, which is located between the pump and the second end, a valve that is provided in the bypass flow path, and a controller. The pump includes an internal flow path that is capable of switching between an open state and a closed state. The controller is communicably connected to the pump and the valve and is set such that, when the pump is driven from a stopped state and when the pump is stopped from a driven state, the valve is opened.

### BACKGROUND OF THE INVENTION

### 1. Field of the Invention

The present invention relates to an ink supply system and an ink jet printer.

### 2. Description of the Related Art

Conventionally, an ink jet printer including a liquid delivery pump has been known. The ink jet printer includes an ink cartridge that stores an ink and an ink head connected to the ink cartridge via a flow path, such as a tube or the like. The liquid delivery pump is provided in the middle of a flow path and supplies the ink to the ink head. In Japanese Laid-open Patent Publication No. 2010-194915, a printer including an ink head, an ink cartridge, a flow path of an ink, and a liquid delivery pump, as described above, is disclosed. The liquid delivery pump is typically a tube pump.

Incidentally, in some cases, when a pump employing a method of switching between an open state and a closed state of an internal flow path, which is typically a tube pump, is used as an ink liquid delivery pump, a problem occurs. FIG. 7A is a cross-sectional view schematically illustrating a tube pump 200 when an internal flow path 202 is in a closed state. FIG. 7B is a cross-sectional view schematically illustrating the tube pump 200 when the internal flow path 202 is in an open state. The tube pump 200 includes a rotary shaft 206 that rotates and two rollers 204 attached to the rotary shaft 206 to press or open the internal flow path 202 by the rollers 204. Therefore, the internal flow path 202 is formed of a tube which has elasticity. When the tube pump 200 is in a stopped state, the rollers 204 are located in a radially inner side of the rotary shaft 206 and the internal flow path 202 is opened. When the tube pump 200 is driven, the rollers 204 moves to a radially outer side of the rotary shaft 206 and the internal flow path 202 is pressed (closed) by the rollers 204 that moves in a rotational direction of the rotary shaft 206. The tube pump 200 delivers liquid by pressing force of the internal flow path 202 generated by the rollers 204.

The tube pump 200 includes the above described structure, and therefore, each time a state of the internal flow path 202 is changed from an open state to a closed state or from a closed state to an open state, the tube pump 200 moves liquid that exists therein. A case in which the internal flow path 202 is changed from an open state to a closed state is a case in which the tube pump 200 is driven from a stopped state. A case in which the internal flow path 202 is changed from a closed state to an opened state is a case in which the tube pump 200 is stopped from a driven state. When the internal flow path 202 in the tube pump 200 is changed from an opened state to a closed state, the liquid is moved in a normal liquid delivery direction (which will be hereinafter referred to as a forward direction). When the internal flow path 202 in the tube pump 200 is changed from a closed state to an opened state, the liquid is moved in an opposite direction (which will be hereinafter referred to as a reverse direction) to the normal liquid delivery direction. In the ink jet printer, when the liquid is moved in the forward direction, oozing of the ink from the ink jet head is caused to occur and, when the liquid is moved in the reverse direction, reverse flow of the ink to the ink cartridge is caused to occur. The oozing and reverse flow are problems that occur when a pump which employs a method of switching between an opening state and a closed state of the internal flow path, which is typically a tube pump, is used as the ink delivery pump of the ink jet printer.

### SUMMARY OF THE INVENTION

Preferred embodiments of the present invention provide ink supply systems that each use a liquid delivery pump to perform a method of switching an open state and a closed state of an internal flow path and includes a mechanism that suppresses oozing of an ink from an ink head and reverse flow of the ink to an ink cartridge. Also, other preferred embodiments of the present invention provide ink jet printers that each include one of the above described ink supply systems.

A first ink supply system according to a preferred embodiment of the present invention includes an ink head that discharges an ink, an ink container that stores the ink, a main flow path including a first end that is connected to the ink container and a second end that is connected to the ink head, a pump that is provided in the main flow path and delivers, when driven, liquid toward a side of the ink head, a bypass flow path including a first connection portion that is connected to a portion of the main flow path, which is located between the pump and the first end, and a second connection portion that is connected to a portion of the main flow path, which is located between the pump and the second end, a valve that is provided in the bypass flow path, and a controller. The pump includes an internal flow path that is capable of switching between an open state and a closed state. The controller is communicably connected to the pump and the valve and is set such that, when the pump is driven from a stopped state and when the pump is stopped from a driven state, the valve is opened.

In the first ink supply system, when the pump is driven/stopped (closed/opened), the valve provided in the bypass flow path is opened, and therefore, a portion of the main flow path, which is interposed between the first connection portion and the second connection portion, and the bypass flow path define a circulation flow path. Liquid that has been moved by the pump circulates in the circulation flow path and a liquid pressure is not applied to the ink head and the ink cartridge. Therefore, oozing of the ink from the ink head and reverse flow of the ink to the ink cartridge are reduced or prevented.

A second ink supply system according to a preferred embodiment of the present invention includes an ink head that discharges an ink, an ink container that stores the ink, a main flow path, a pump, a bypass flow path, a connector, a direction control valve, and a controller. The main flow path includes a first flow path that includes a first upstream end that is connected to the ink container and a first downstream end, a second flow path that includes a second upstream end and a second downstream end, and a third flow path that includes a third upstream end and a third downstream end that is connected to the ink head. The pump includes an internal flow path that is capable of switching between an open state and a closed state, is provided in the second flow path, and delivers, when driven, liquid toward a side of the ink head. The bypass flow path includes a first connection portion and a second connection portion. The connector connects the second downstream end, the third upstream end, and the second connection portion. The direction control valve includes a first port that is connected to the first downstream end, a second port that is connected to the first connection portion, and a third port that is connected to the second upstream end and is capable of switching between a first state in which the first port and the third port are communicated and a second state in which the second port and the third port are communicated. The controller is communicably connected to the pump and the direction control valve and controls the pump and the direction control valve. The controller is set such that, when the pump is driven from a stopped state and when the pump is stopped from a driven state, the direction control valve is put in the second state.

In the second ink supply system, similar to the first ink supply system, when the pump is driven/stopped, it is possible to cause the ink that is moved by the pump to circulate in the circulation flow path. When the ink is caused to circulate in the circulation flow path, as a state of the direction control valve, the second state in which the circulation flow path is defined is selected. Furthermore, in the second ink supply system, the direction control valve is provided in a connection portion, among the connection portions of the main flow path and the bypass flow path, which is located at a side of the ink container. Then, when the second state is selected, a flow path that connects the ink container and the pump is disconnected, and therefore, the ink does not move to the side of the ink cartridge. Thus, reverse flow of the ink to the ink container is able to be more reliably reduced or prevented.

Furthermore, a third ink supply system according to a preferred embodiment of the present invention includes an ink head that discharges an ink, an ink container that stores the ink, a main flow path, a pump, a bypass flow path, a connector, a direction control valve, and a controller. The main flow path includes a first flow path that includes a first upstream end that is connected to the ink container and a first downstream end, a second flow path that includes a second upstream end and a second downstream end, and a third flow path that includes a third upstream end and a third downstream end that is connected to the ink head. The pump includes an internal flow path that is capable of switching between an open state and a closed state, is provided in the second flow path, and delivers, when driven, liquid toward a side of the ink head. The bypass flow path includes a first connection portion and a second connection portion. The connector connects the first downstream end, the second upstream end, and the first connection portion. The direction control valve includes a first port that is connected to the second downstream end, a second port that is connected to the second connection portion, and a third port that is connected to the third upstream end and is capable of switching between a first state in which the first port and the third port are communicated and a second state in which the first port and the second port are communicated. The controller is communicably connected to the pump and the direction control valve and controls the pump and the direction control valve. The controller is set such that, when the pump is driven from a stopped state and when the pump is stopped from a driven state, the direction control valve is put in the second state.

In the third ink supply system, similar to the first and second ink supply systems, when the pump is driven/stopped, it is possible to cause the ink that is moved by the pump to circulate in the circulation flow path. When the ink is caused to circulate in the circulation flow path, as a state of the direction control valve, the second state in which the circulation flow path is defined is selected. Furthermore, in the third ink supply system, the direction control valve is provided in a connection portion, among the connection portions of the main flow path and the bypass flow path, which is located at a side of the ink head. Then, when the second state is selected, a flow path that connects the ink head and the pump is disconnected, and therefore, the ink does not move to the side of the ink head. Thus, oozing of the ink from the ink head is able to be more reliably reduced or prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printer according to a first preferred embodiment of the present invention.

FIG. 2 is a conceptual diagram illustrating an ink supply system.

FIG. 3 is a schematic diagram illustrating an ink supply mechanism.

FIG. 4 is a block diagram pertaining to a printer.

FIG. 5 is a schematic diagram illustrating an ink supply mechanism according to a second preferred embodiment of the present invention and illustrating a state in which a first flow path is selected.

FIG. 6 is a schematic diagram illustrating an ink supply mechanism according to the second preferred embodiment of the present invention and illustrating a state in which a second flow path is selected.

FIG. 7A is a cross-sectional view schematically illustrating a tube pump when an internal flow path is in a closed state.

FIG. 7B is a cross-sectional view schematically illustrating a tube pump when an internal flow path is in an opened state.

### DETAILED DESCRIPTION OF THE PREFERRED EMBODIMENTS

Ink supply systems according to preferred embodiments of the present invention and ink jet printers (which will be hereinafter merely referred to as printers) including the ink supply systems will be described below with reference to the accompanying drawings. Note that, as a matter of course, the preferred embodiments described herein are not intended to be particularly limiting of the present invention. Also, members and elements that have the same function are denoted by the same reference sign and redundant description will be omitted or simplified, as appropriate.

### First Preferred Embodiment

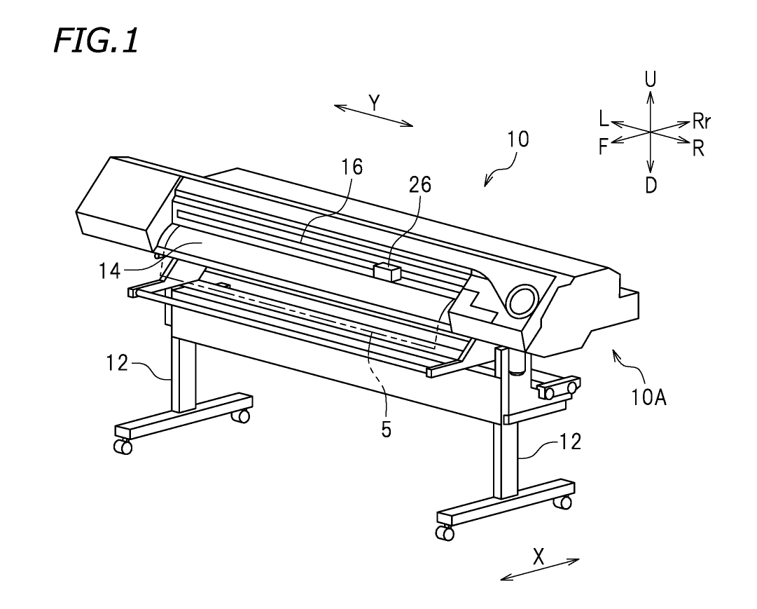

FIG. 1 is a perspective view of a printer 10 according to a first preferred embodiment of the present invention. In FIG. 1, when the printer 10 is viewed from front, a direction away from the printer 10 will be referred to as front and a direction toward the printer 10 will be referred to as rear. The terms left, right, up and down refer to these directions when the printer 10 is viewed from the front. The reference signs F, Rr, L, R, U and D as used in the drawings refer to front, rear, left, right, up and down, respectively. However, the above described directions are used merely for the sake of convenience of description, are not intended to limit how the printer 10 is installed in any way, and are not intended to limit the present invention in any way. The reference sign Y as used in the drawings denotes a main scanning direction. Herein, the main scanning direction Y is a left-right direction. The reference sign X denotes a sub scanning direction. Herein, the sub scanning direction X is a front-rear direction. The main scanning direction Y and the sub scanning direction X are perpendicular to one another as viewed from top. However, there is no particular limitation on the main scanning direction Y and the sub scanning direction X, and these directions can be set appropriately in accordance with each preferred embodiment of the printer 10.

The printer 10 according to this preferred embodiment is an ink jet printer, for example. In this preferred embodiment, an “ink jet system” includes various continuous methods, such as a binary deflection method, a continuous deflection method, or the like, and various on-demand methods, such as a thermal method, a piezoelectric method, or the like. The printer 10 performs printing on a recording medium 5.

The recording medium 5 is, for example, recording paper. However, the recording medium 5 is not limited to recording paper. For example, the recording medium 5 may be a sheet-type recording medium, such as, for example, a sheet made of a resin, such as PVC, polyester, or the like. The recording medium 5 may be also a medium made of aluminum, iron, wood, leather, or the like. Flexibility or thickness of the recording medium 5 do not matter. That is, the recording medium 5 may be made of a hard material, such as a glass substrate or the like, and may be made of a thick material, such as cardboard or the like.

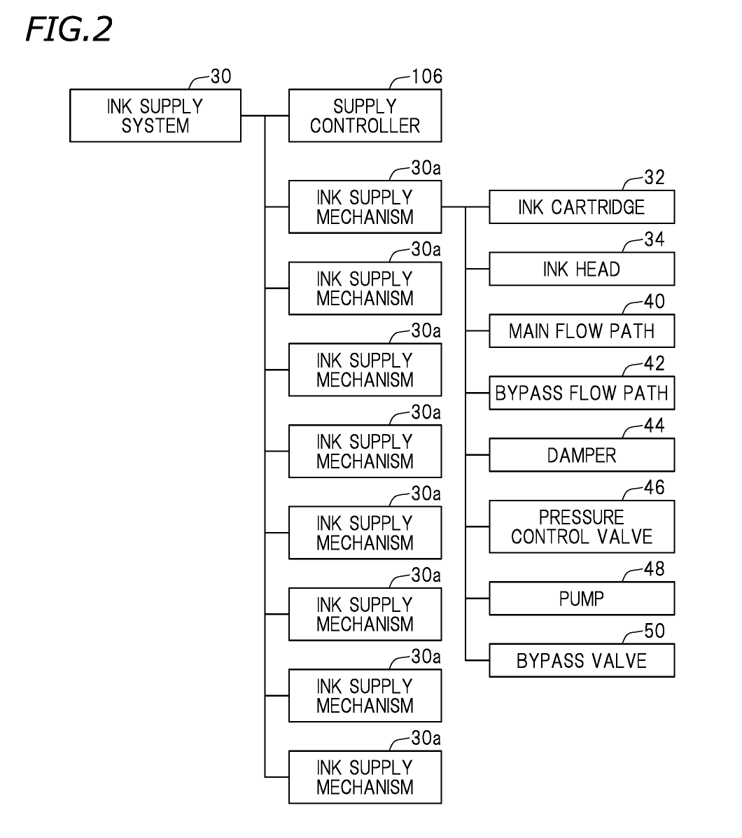

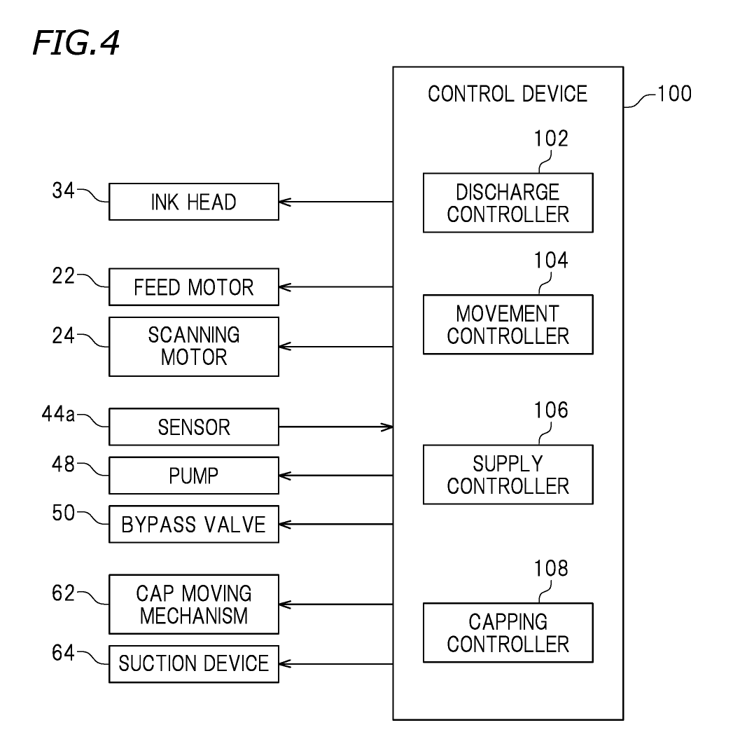

The printer 10 includes a main body 10A, legs 12, a platen 14, a guide rail 16, and an ink supply system 30 (see FIG. 2). The main body 10A is supported by the legs 12. The legs 12 are provided on a lower surface of the main body 10A. The recording medium 5 is placed on the platen 14. Although not illustrated in the drawings, cylindrical grit rollers are provided in the platen 14. The grit rollers are buried in the platen 14 in a state in which upper surfaces thereof are exposed. The grit rollers are installed so as to rotate in the sub scanning direction X and is caused to rotate by a feed motor 22 (see FIG. 4).

The guide rail 16 is arranged over the platen 14. The guide rail 16 is arranged in parallel or substantially parallel to the platen 14 and extends in the main scanning direction Y. Although not illustrated in the drawings, a plurality of pinch rollers is arranged at regular or substantially regular intervals under the guide rail 16. These pinch rollers are opposed to the grit rollers. The pinch rollers are configured such that positions thereof in an up-down direction can be set in accordance with the thickness of the recording medium 5. The recording medium 5 is interposed between the grit rollers and the pinch rollers. The grit rollers and the pinch rollers are configured so as to be able to convey the recording medium 5 in the sub scanning direction X with the recording medium 5 interposed therebetween. The recording medium 5 is conveyed on the platen 14 by rotation of the grit rollers by the feed motor 22.

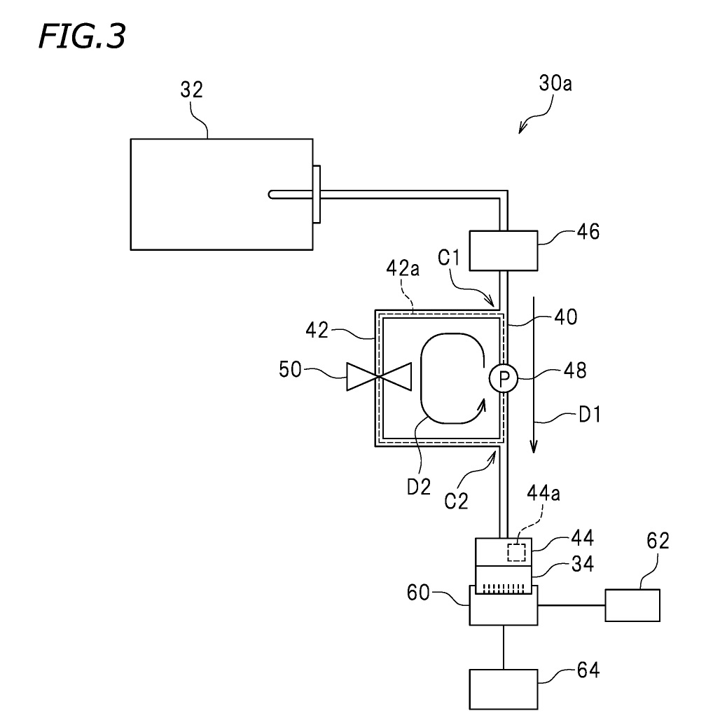

Next, the ink supply system 30 will be described. FIG. 2 is a conceptual diagram illustrating the ink supply system 30. FIG. 3 is a schematic view illustrating an ink supply mechanism 30a. In this preferred embodiment, as illustrated in FIG. 2, the ink supply system 30 includes a plurality of ink supply mechanisms 30a and a supply controller 106. In one example of a preferred embodiment of the present invention, the ink supply system is a non-circulation type ink supply system. The supply controller 106 is a part of a control device 100 (see FIG. 4). As illustrated in FIG. 3, the ink supply mechanism 30a supplies an ink from an ink cartridge 32, which will be described later, toward an ink head 34. The ink supply system 30 includes the ink supply mechanisms 30a of the same number as the number of the ink heads 34. In this preferred embodiment, the number of the ink heads 34 is “8”, and therefore, as illustrated in FIG. 2, the number of the ink supply mechanisms 30a is “8”, for example. However, there is no particular limitation on the number of the ink heads 34 and the number of the ink supply mechanisms 30a. Note that each of the plurality of ink supply mechanisms 30a has the same configuration. Therefore, a configuration of one ink supply mechanism 30a will be described in detail below.

As illustrated in FIG. 3, each of the ink supply mechanisms 30a in the ink supply system 30 includes the ink head 34, the ink cartridge 32, a main flow path 40, a bypass flow path 43, a damper 44, a pressure control valve 46, a pump 48, and a bypass valve 50.

The ink head 34 discharges an ink to the recording medium 5 that is placed on the platen 14. A nozzle that discharges the ink is on a bottom surface of the ink head 34. Although not illustrated in the drawings, the ink head 34 is mounted on a carriage 26. As illustrated in FIG. 1, the carriage 26 engages with the guide rail 16. The carriage 26 is slidable along the guide rail 16 and is movable in the main scanning direction Y. Accordingly, the plurality of ink heads 34 is movable in the main scanning direction Y along the guide rail 16 via the carriage 26. A moving mechanism that causes the ink heads 34 to move in the main scanning direction Y is connected to the ink heads 34. There is no particular limitation on a configuration of the moving mechanism. In this preferred embodiment, although not illustrated in the drawings, a portion of a driving belt that extends in the main scanning direction Y is fixed to an upper portion of a back surface of the carriage 26. The driving belt is electrically connected to a scanning motor 24 (see FIG. 4). The scanning motor 24 is driven, and thus, the carriage 26 and the plurality of ink heads 34 mounted on the carriage 26 move in the main scanning direction Y.

The ink cartridge 32 stores an ink. In this preferred embodiment, the number of ink cartridges 32 is the same as the number of the ink heads 34, for example. One ink head 34 is connected to one ink cartridge 32. The ink stored in the ink cartridge 32 is supplied to the ink head 34. Normally, inks of different colors are stored in the plurality of ink cartridges 32. However, some of the plurality of ink cartridges 32 may store inks of the same color. There is no particular limitation on a color type of an ink that is stored in each of the ink cartridges 32. For example, the ink that is stored in each of the ink cartridges 32 is any one of process color inks, such as a cyan ink, a magenta ink, a yellow ink, a black ink, a light cyan ink, a light magenta ink, a light black ink, or the like, and a special color ink, such as a white ink, a metallic ink, and clear ink, or the like.

As illustrated in FIG. 3, a main flow path 40 is a flow path through which the ink stored in the ink cartridge 32 is supplied to the ink head 34. There is no particular limitation on type and material of the main flow path 40. The main flow path 40 is, for example, a flexible tube.

A pump 48 is provided in the middle of the main flow path 40. The pump 48 supplies the ink that is stored in the ink cartridge 32 to the ink head 34. When driven, the pump 48 delivers the ink from a side of the ink cartridge 32 toward a side of the ink head 34. The pump 48 performs a method of switching between an open state and a closed state of an internal flow path. The pump 48 is configured such that an open state/a closed state of the internal flow path is changed in accordance with a drive state. Specifically, in the pump 48, when the pump 48 is driven, the internal flow path is closed (pressed) and, when the pump 48 is stopped, the internal flow path is opened. There is no further limitation on a type of the pump 48. In this preferred embodiment, the pump 48 is a tube pump, for example.

Both ends of a bypass flow path 42 are connected to the main flow path 40 with the pump 48 interposed therebetween. That is, one end of the bypass flow path 42 is connected to the main flow path 40 by a first connection portion C1 located closer to the ink cartridge 32 than the pump 48 and the other end is connected to the main flow path 40 by a second connection portion C2 located closer to the ink head 34 than the pump 48. In the following description, a portion of a flow path, which is closer to the ink cartridge 32, will be referred to as an upstream and a portion of the flow path, which is closer to the ink head 34, will be referred to as a downstream. A portion of the main flow path 40, which is interposed between the first connection portion C1 and the second connection portion C2, and the bypass flow path 42 define a circulation flow path 42a. There is no limitation also on type and material of the bypass flow path 42. In this preferred embodiment, similar to the main flow path 40, the bypass flow path 42 is a flexible tube, for example.

The bypass valve 50 is provided in the middle of the bypass flow path 42. There is no particular limitation on a type of the bypass valve 50. The bypass valve 50 is, for example, a solenoid valve. The bypass valve 50 is controlled by a drive signal that is transmitted from the control device 100.

A damper 44 is provided in a portion just upstream of the ink head 34. The damper 44 reduces fluctuation in a pressure of an ink and stabilizes a discharge operation of the ink head 34. The damper 44 according to this preferred embodiment includes a storage chamber that stores an ink and a sensor 44a that detects a pressure of the ink that is stored in the storage chamber. When printing is performed, the damper 44 reduces fluctuation of the pressure of the ink by keeping the pressure of the ink that is stored in the storage chamber in a fixed range. The pressure of the ink that is stored in the storage chamber is detected by the sensor 44a. The sensor 44a is, for example, a photo sensor used for position detection. One of wall surfaces of the storage chamber is a film that expands and contracts and the film sinks inward and sticks outward in accordance with the pressure of the ink that is stored in the storage chamber. The sensor 44a detects the pressure of the ink in the storage chamber, based on a sinking or sticking position of the film. When the film expands to excess a fixed position, the sensor 44a transmits an upper limit signal to the control device 100. When the film contracts to retreat from the fixed position, the sensor 44a transmits a lower limit signal to the control device 100. As a matter of course, a pressure detector of the damper is according to one preferred embodiment and a detector that detects the pressure in the ink in the storage chamber is not limited to the above described detector.

The pressure control valve 46 is provided in a portion of the main flow path 40, which is located between the ink cartridge 32 and the pump 48. The pressure control valve 46 maintains inside of the ink head 34 at a negative pressure when an ink is not discharged. The inside of the ink head 34 is maintained at a negative pressure, and thus, dripping of the ink in the ink head 34 from the nozzle to outside is able to be reduced or prevented. The ink in the ink head 34 is maintained at around −1 kPa by the pressure control valve 46, for example. The pressure control valve 46 includes a flow path through which an ink flows and a valve system that opens and closes the flow path. The valve system is configured to open and close in accordance with a liquid pressure in a part located downstream of the valve system. A liquid pressure of the ink in a portion located upstream of the valve system, the liquid pressure of the ink in a portion located downstream of the valve system, a mechanical force that functions to close the valve system, and a mechanical force that functions to open the valve system are applied to the valve system. When the printer is not used, these forces are balanced with one another. In this balanced state, the valve system blocks the flow path. The liquid pressure of the ink then is the liquid pressure of the ink at rest, which is maintained at about −1 kPa, for example. A mechanical force that closes or opens the valve system is, for example, a restoration force of a spring. When the pump 48 is operated and the ink is sucked out from a portion located downstream of the valve system, the liquid pressure of the ink in the portion located downstream of the valve system is reduced and the balance is lost, so that the valve system moves in an open direction. When the valve system is opened, the flow path is opened and the ink is supplied in a downstream direction. By the above described mechanism, the pressure control valve 46 maintains the ink at a negative pressure when the printer is not used, and sends out the ink in a direction toward the ink head 34 when the printer is used.

In this preferred embodiment, the ink supply mechanism 30a includes a cap 60, a cap moving mechanism 62, and a suction device 64. Although not illustrated in the drawings, the cap 60 and the suction device 64 are arranged under a home position that is located in a right end of the guide rail 16. The home position is a position in which the ink head 34 stands by when the printer is in a print standby state. The cap 60 reduces or prevents curing of the ink that has adhered to the nozzle of the ink head 34 and clogging of the nozzle. As illustrated in FIG. 3, when the printer is in a standby state, the cap 60 is loaded in the ink head 34 from a lower side so as to cover a nozzle surface of the ink head 34. The cap moving mechanism 62 is connected to the cap 60. The cap moving mechanism 62 moves the cap 60 toward or away from a bottom surface of the ink head 34. The cap moving mechanism 62 is, for example, a driving motor and a ball screw mechanism.

The suction device 64 sucks an ink and air in the cap 60. The suction device 64 is, for example, a suction pump. The suction device 64 is connected to the cap 60. The suction device 64 is driven in a state in which the cap 60 is loaded in the ink head 34, and thus, sucks the ink and air in the cap 60, the ink head 34, and the main flow path 40.

The control device 100 controls at least a portion of the above described mechanism. FIG. 4 is a block diagram pertaining to the printer 10. The control device 100 is configured or programmed a discharge controller 102, a movement controller 104, a supply controller 106, and a capping controller 108. There is no particular limitation on a configuration of the control device 100. For example, the control device 100 may be a computer and include a central processing unit (which will be hereinafter referred to as a CPU), a ROM that stores a program or the like that is executed by the CPU, a RAM, or the like.

The discharge controller 102 is connected to the ink head 34. The discharge controller 102 controls a timing at which the ink is discharged by controlling a discharging mechanism (for example, a piezoelectric element) of the ink head 34.

The movement controller 104 is connected to the feed motor 22 and the scanning motor 24. The movement controller 104 controls movement of the recording medium 5 in the sub scanning direction X by controlling the feed motor 22. The movement controller 104 also controls movement of the ink head 34 in the main scanning direction Y by controlling the scanning motor 24.

The supply controller 106 is connected to the sensor 44a of the damper 44, the pump 48, and the bypass valve 50 and controls supply of the ink to the ink head 34. When the supply controller 106 receives the upper limit signal from the sensor 44a of the damper 44, the supply controller 106 controls the pump 48 and stops liquid delivery to the damper 44. When the supply controller 106 receives the lower limit signal, the supply controller 106 controls the pump 48 and starts liquid delivery to the damper 44. By repeating such feedback control, liquid delivery by the pump 48 is controlled and pressure fluctuation of the ink is suppressed. When the pump 48 is driven/stopped, the supply controller 106 opens the bypass valve 50. While the pump 48 is steadily driven, the supply controller 106 closes the bypass valve 50. In this preferred embodiment, while the pump 48 is in a stopped state, the supply controller 106 closes the bypass valve 50. The above described control is a basic control. However, it is not prevented from performing control other than the above described basic control for maintenance or the like.

The capping controller 108 is connected to the cap moving mechanism 62 and the suction device 64 and controls movements of the cap 60 and the suction device 64.

Each of these elements of the control device 100 may be configured by a software and may be configured by a hardware. Each of these elements may be performed by a processor and may be incorporated in a circuit.

The printer 10 according to this preferred embodiment is configured such that the discharge controller 102 controls a timing at which the ink is discharged from each of the ink heads 34 and the movement controller 104 controls the scanning motor 24 and moves the ink heads 34 mounted in the carriage 26, and thereby, the printer 10 performs printing on the recording medium 5. When printing ends in one sub scanning direction X position, the movement controller 104 controls the feed motor 22 and sends the recording medium 5 by a predetermined distance in the sub scanning direction X. Thus, the printer 10 performs printing on the recording medium 5.

Incidentally, as described above, in an ink jet printer including a liquid delivery pump which is typically a tube pump and in which an internal flow path is closed when driven, and the internal flow path is opened when stopped, each time a state of the flow path in the pump is changed from an open state to a closed state or from a closed state to an open state, an ink that exists in the pump is moved. When the ink is moved in the forward direction, oozing of the ink from an ink head is caused to occur and, when the ink is moved in the reverse direction, reverse flow of the ink to the ink cartridge is caused to occur.

Then, as illustrated in FIG. 3, the ink supply system 30 according to this preferred embodiment includes the bypass flow path 42 one end of which is connected to the main flow path 40 in a position located upstream of the pump 48 and the other end of which is connected to the main flow path 40 in a position located downstream of the pump 48. The ink supply system 30 includes the bypass valve 50 in the bypass flow path 42. The supply controller 106 of the control device 100 controls the pump 48 and the bypass valve 50 and it is set to open the bypass valve 50 when the pump 48 is driven from a stopped state and when the pump 48 is stopped from a driven state.

According to the above described preferred embodiment, when the pump 48 is driven/stopped, the bypass valve 50 is opened, and therefore, the ink that has been moved by the pump 48 circulates in the circulation flow path 42a. The ink circulates in the circulation flow path 42a, and thus, oozing of the ink from the ink head 34 and reverse flow of the ink to the ink cartridge 32 are reduced or prevented.

In the ink supply system 30 according to this preferred embodiment, the bypass valve 50 is set to be closed after the pump 48 is driven from a stopped state. That is, the bypass valve 50 is set to be closed when the pump 48 is steadily driven. While the pump 48 is steadily driven, the bypass flow path 42 is disconnected and the circulation flow path 42a is not defined. Accordingly, the ink is supplied to the ink head 34 without circulating.

In FIG. 3, a flow of the ink when the pump 48 is driven/stopped is indicated by a direction D2. As indicated by the direction D2, when the pump 48 is driven/stopped, the ink circulates in the circulation flow path 42a. In FIG. 3, a direction indicated by a direction D1 is a direction in which the ink flows when the pump 48 is steadily driven. When the pump 48 is steadily driven, the ink linearly flows from the ink cartridge 32 toward the ink head 34, as indicated by the direction D1.

In this preferred embodiment, the main flow path 40 includes a flexible tube and the pump 48 is a tube pump. In the ink supply system 30, the flexible tube is convenient to handle and cost thereof is low. The tube pump is compact in size, and therefore, installation thereof in the ink supply system 30 is easy. Design and production of the ink supply system 30 are facilitated by using a flexible tube for the main flow path 40 and using a tube pump for the pump 48, and also, costs are reduced or prevented. When a tube pump is used as the pump 48, preferred embodiments of the present invention exhibits achieve advantageous effects.

Note that the supply controller 106 may be configured such that it is set to open, when the supply controller 106 causes the pump 48 to be driven from a stopped state and when the supply controller 106 causes the pump 48 to be stopped from a driven state, the bypass valve 50 in advance of driving/stopping of the pump 48. By the above described control, the bypass valve 50 is reliably opened at a timing at which the pump 48 is driven/stopped. In contrast, if control is performed such that a timing of driving/stopping of the pump 48 and a timing of opening of the bypass valve are the same, there is a risk that it is delayed to define the circulation flow path 42a, even by an instant, and oozing of the ink from the ink head 34 or reverse flow of the ink to the ink cartridge 32 is caused to occur. That is, oozing of the ink from the ink head 34 or reverse flow of the ink to the ink cartridge are able to be more reliably reduced or prevented by controlling the pump 48 and the bypass valve 50 in the above described manner.

A time by which opening of the bypass valve 50 is caused to precede driving/stopping of the pump 48 is, for example, about one second, if the bypass valve 50 is a solenoid valve. A time which it takes to fully open the solenoid valve is short, and therefore, a time of about one second is enough to address the above described inconvenience. If the bypass valve 50 is a valve of some other type, such as, for example, a rotary ball valve or the like, a time by which opening of the bypass valve 50 is caused to precede is determined in consideration of a time for which the bypass valve 50 is fully opened.

A time from driving of the pump 48 to closing of the bypass valve 50 is a time until the pump 48 is stabilized to be in a state in which the pump 48 is able to deliver liquid in the forward direction. The time is at least a time equal to or more than a time for which the rotary shaft in the pump 48 rotates one rotation, if the pump 48 is a tube pump, and is preferably longer than the time.

### Second Preferred Embodiment

A second preferred embodiment of the present invention is a preferred embodiment in which a direction control valve (three-way valve) is provided in a connection portion between a main flow path and a bypass flow path. The second preferred embodiment is similar to the first preferred embodiment, except that the three-way valve is provided in the connection portion and except for a control method of the three-way valve. Therefore, also in description of the second preferred embodiment, each member that is the same as that in the first preferred embodiment is denoted by the same reference sign as that in the first preferred embodiment and redundant description will be omitted.

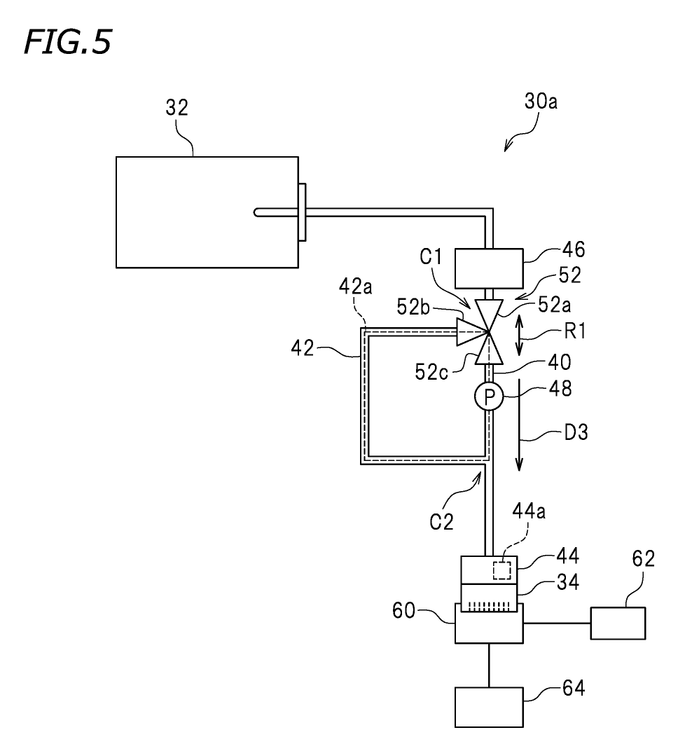

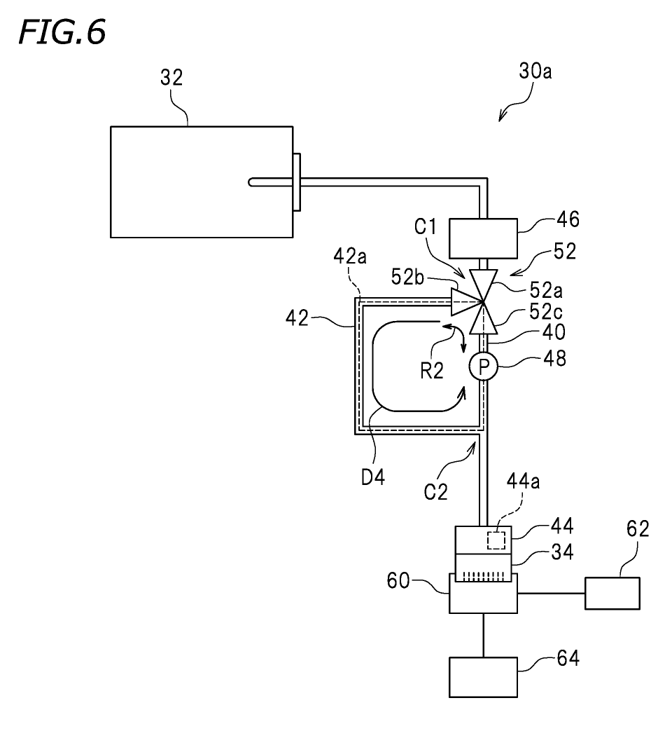

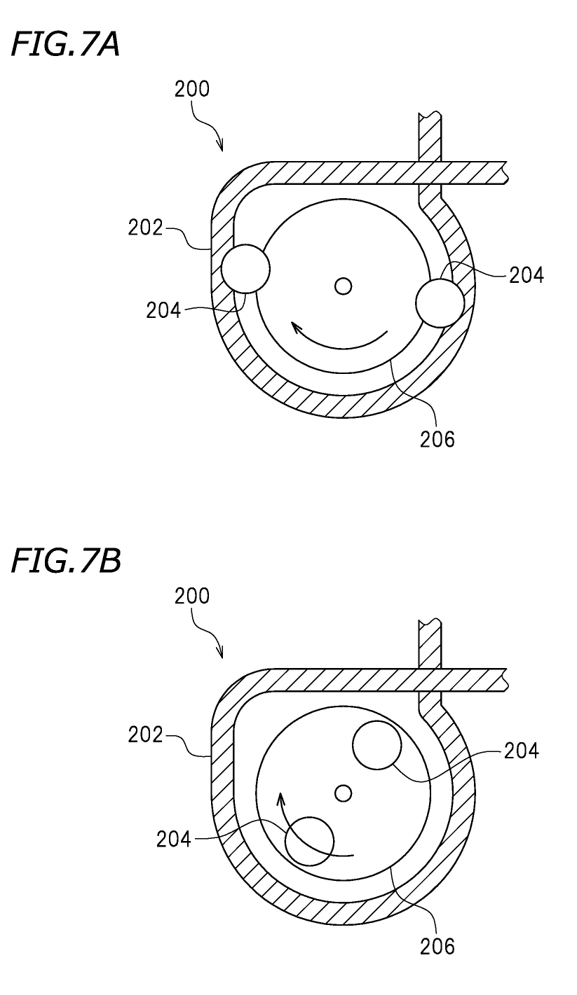

FIG. 5 is a schematic diagram illustrating an ink supply mechanism 30a according to this preferred embodiment. In this preferred embodiment, a three-way valve 52 is provided in one of connection portions of a main flow path 40 and a bypass flow path 42, which is located in an upstream side. That is, the three-way valve 52 is provided in a first connection portion C1 that is located in a side closer to the ink cartridge 32. Another one of the connection portions of the main flow path 40 and the bypass flow path 42, which is located in a downstream side, is a second connection portion C2. The three-way valve 52 includes a common port 52c in a side closer to the pump 48, a first port 52a in a side closer to the ink cartridge 32, and a second port 52b at a side closer to the bypass flow path 42. The three-way valve 52 is, for example, a solenoid three-way valve and is configured to alternatively switch between communicating the common port 52c and the first port 52a and communicating the common port 52c and the second port 52b. A driving portion of the three-way valve 52 is electrically connected to a supply controller 106 and a signal that commands the above described switching is transmitted from the supply controller 106. When a side of a first flow path R1 that communicates the common port 52c and the first port 52a is selected as a flow path, the ink cartridge 32 and the ink head 34 are communicated via the main flow path 40. When a side of a second flow path R2 (see FIG. 6) that communicates the common port 52c and the second port 52b is selected as a flow path, the main flow path 40 and the bypass flow path 42 are communicated and a circulation flow path 42a is defined. FIG. 5 illustrates the ink supply mechanism 30a in a state in which the first flow path R1 is selected. The first flow path R1 is indicated by an arrow denoted by a reference sign R1 in FIG. 5. On the other hand, FIG. 6 illustrates the ink supply mechanism 30a in a state in which the second flow path R2 is selected. The second flow path R2 is indicated by an arrow denoted by a reference sign R2 in FIG. 6.

The supply controller 106 in this preferred embodiment performs control of switching a flow path direction of the three-way valve 52 in accordance with an operating state of the pump 48. The supply controller 106 is set such that, when the pump 48 is driven from a stopped state and when the pump 48 is stopped from a driven state, the first flow path R1 is closed and the second flow path R2 is communicated. That is, when the pump 48 is driven/stopped, a flow path state illustrated in FIG. 6 is selected.

The supply controller 106 is set such that, after the pump 48 is driven from a stopped state, the second flow path R2 is closed and the first flow path R1 is communicated. That is, when the pump 48 is steadily driven, a flow path state illustrated in FIG. 5 is selected.

As in the state in FIG. 6, in a state in which the second flow path R2 is communicated by the three-way valve 52, an ink that has been moved by an opening and closing operation of the pump 48 circulates in the circulation flow path 42a as indicated by a direction D4. As described above, also in the second preferred embodiment, the circulation flow path 42a can be configured similar to the first preferred embodiment, and therefore, similar to the first preferred embodiment, oozing of the ink from the ink head 34 and reverse flow of the ink to the ink cartridge 32 are able to be reduced or prevented. Furthermore, in the ink supply mechanism 30a according to this preferred embodiment, the three-way valve 52 is provided in the first connection portion C1. Then, when the second flow path R2 is selected, a flow path that connects the side of the ink cartridge 32 and the pump 48 is disconnected, and therefore, the ink does not move to the side of the ink cartridge 32. That is, reverse flow of the ink to the ink cartridge 32 is able to be more reliably reduced or prevented.

On the other hand, as in the state in FIG. 5, in a state in which the first flow path R1 is communicated by the three-way valve 52 and the pump 48 is steadily driven, the ink is supplied to the ink head 34 through the main flow path 40 as indicated by a direction D3. As described above, also in the second preferred embodiment, similar to the first preferred embodiment, the circulation flow path 42a can be disconnected, and therefore, similar to the first preferred embodiment, the ink is able to be directly supplied to the ink head 34.

In this preferred embodiment, the main flow path 40 may include a flexible tube and also the pump 48 may be a tube pump. Advantages of defining the main flow path 40 of a tube and defining the pump 48 of a tube pump are similar to those in the first preferred embodiment.

Also, in the second preferred embodiment, a timing of driving/stopping of the pump 48 and a switching timing of the three-way valve 52 may be adjusted. That is, the supply controller 106 may be set such that, when the pump 48 is driven from a stopped state and when the pump 48 is stopped from a driven state, the first flow path R1 is closed and the second flow path R2 is communicated in advance of driving or stopping of the pump 48. Advantages of the above described control are similar to those in the first preferred embodiment.

As has been described above, two preferred embodiments have been described but an ink supply system according to the present invention and an ink jet printer including the ink supply system are not limited to the above described preferred embodiments.

For example, although, in the second preferred embodiment, the three-way valve 52 is provided in the first connection portion C1, the three-way valve 52 may be provided in the second connection portion C2. According to the above described preferred embodiments, oozing of the ink from the ink head 34 is able to be more reliably reduced or prevented. The three-way valve 52 may be provided in both of the first connection portion C1 and the second connection portion C2.

In an ink supply mechanism according to a preferred embodiment of the present invention, a main flow path may be connected to a plurality of ink cartridges. Inks of the same type are stored in the plurality of ink cartridges.

Although, in the above described preferred embodiments, an ink supply system according to a preferred embodiment of the present invention is applied to an ink jet printer, application of an ink supply system according to a preferred embodiment of the present invention is not limited to an ink jet printer. For example, an ink supply system according to a preferred embodiment of the present invention is applicable to a powder curing 3D printer or the like, which includes an ink head.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-9. (canceled)

10: A non-circulation type ink supply system comprising:
an ink head that discharges an ink;
an ink container that stores the ink;
a main flow path including a first end that is connected to the ink container and a second end that is connected to the ink head;
a pump that includes an internal flow path that is capable of switching between an open state and a closed state, is provided in the main flow path, and delivers, when driven, liquid toward a side of the ink head;
a bypass flow path including a first connection portion that is connected to a portion of the main flow path, which is located between the pump and the first end, and a second connection portion that is connected to a portion of the main flow path, which is located between the pump and the second end;
a valve that is provided in the bypass flow path; and
a controller that is communicably connected to the pump and the valve and is set such that, when the pump is driven from a stopped state and when the pump is stopped from a driven state, the valve is opened.

11: The non-circulation type ink supply system according to claim 10, wherein the controller is set such that, after the pump is driven from a stopped state, the valve is closed.

12: The non-circulation type ink supply system according to claim 10, wherein the controller is set such that, when the pump is driven from a stopped state and when the pump is stopped from a driven state, the valve is opened in advance of driving or stopping the pump.

13: The non-circulation type ink supply system according to claim 10, wherein
the main flow path includes a flexible tube; and
the pump is a tube pump.

14: An ink jet printer comprising:
the non-circulation type ink supply system according to claim 10.

15: An ink supply system comprising:
an ink head that discharges an ink;
an ink container that stores the ink;
a main flow path including a first flow path that includes a first upstream end that is connected to the ink container and a first downstream end, a second flow path that includes a second upstream end and a second downstream end, and a third flow path that includes a third upstream end and a third downstream end that is connected to the ink head;
a pump that includes an internal flow path that is capable of switching between an open state and a closed state, is provided in the second flow path, and delivers, when driven, liquid toward a side of the ink head;
a bypass flow path including a first connection portion and a second connection portion;
a connector that connects the second downstream end, the third upstream end, and the second connection portion;
a direction control valve that includes a first port that is connected to the first downstream end, a second port that is connected to the first connection portion, and a third port that is connected to the second upstream end and is capable of switching between a first state in which the first port and the third port are communicated and a second state in which the second port and the third port are communicated; and
a controller that is communicably connected to the pump and the direction control valve and controls the pump and the direction control valve; wherein
the controller is set such that, when the pump is driven from a stopped state and when the pump is stopped from a driven state, the direction control valve is put in the second state.

16: The ink supply system according to claim 15, wherein the controller is set such that, after the pump is driven from a stopped state, the direction control valve is put in the first state.

17: The ink supply system according to claim 15, wherein the controller is set such that, when the pump is driven from a stopped state and when the pump is stopped from a driven state, the direction control valve is put in the second state in advance of driving or stopping the pump.

18: The ink supply system according to claim 15, wherein
the main flow path includes a flexible tube; and
the pump is a tube pump.

19: An ink jet printer comprising:
the ink supply system according to claim 15.

20: An ink supply system comprising:
an ink head that discharges an ink;
an ink container that stores the ink;
a main flow path including a first flow path that includes a first upstream end that is connected to the ink container and a first downstream end, a second flow path that includes a second upstream end and a second downstream end, and a third flow path that includes a third upstream end and a third downstream end that is connected to the ink head;
a pump that includes an internal flow path that is capable of switching between an open state and a closed state, is provided in the second flow path, and delivers, when driven, liquid toward a side of the ink head;
a bypass flow path including a first connection portion and a second connection portion;
a connector that connects the first downstream end, the second upstream end, and the first connection portion;
a direction control valve that includes a first port that is connected to the second downstream end, a second port that is connected to the second connection portion, and a third port that is connected to the third upstream end and is capable of switching between a first state in which the first port and the third port are communicated and a second state in which the first port and the second port are communicated; and
a controller that is communicably connected to the pump and the direction control valve and controls the pump and the direction control valve; wherein
the controller is set such that, when the pump is driven from a stopped state and when the pump is stopped from a driven state, the direction control valve is put in the second state.

21: The ink supply system according to claim 20, wherein the controller is set such that, after the pump is driven from a stopped state, the direction control valve is put in the first state.

22: The ink supply system according to claim 20, wherein the controller is set such that, when the pump is driven from a stopped state and when the pump is stopped from a driven state, the direction control valve is put in the second state in advance of driving or stopping the pump.

23: The ink supply system according to claim 20, wherein
the main flow path includes a flexible tube; and
the pump is a tube pump.

24: An ink jet printer comprising:
the ink supply system according to claim 20.
